(19) United States
(12) Patent Application Publication
(10) Pub. No.: US 2026/0264717 A1
(43) Pub. Date: Sep. 10, 2026

(54) INFORMATION PROCESSING METHOD, INFORMATION PROCESSING DEVICE, INFORMATION PROCESSING PROGRAM PRODUCT, AND STORAGE MEDIUM

(71) Applicant: DENSO CORPORATION, Kariya-city (JP)

(72) Inventors: Takuma ARIO, Kariya-city (JP); Kengo KOSAKA, Kariya-city (JP)

(21) Appl. No.: 19/442,467

(22) Filed: Jan. 7, 2026

Related U.S. Application Data
(63) Continuation of application No. PCT/JP2024/022922, filed on Jun. 25, 2024.

(30) Foreign Application Priority Data
Jul. 11, 2023 (JP) 2023-114032

(51) Int. Cl. B60W 60/00; G05D 1/43

(52) U.S. Cl. CPC B60W 60/001; G05D 1/43; B60W 2720/10; B60W 2720/12; B60W 2720/14

(57) ABSTRACT

An information processing method includes: displaying a limit route having a curve shape that is a limit of an allowable trace of the target route by the autonomous device from a start node of the target route. The information processing method further includes receiving an input of the target route from the start node at which the limit route is displayed. The limit route is a route that correlates with a state value for a yaw rate estimated by the autonomous device as an upper limit within an allowable range in which the trace is established, and a target speed that is targeted for autonomous traveling along the target route.

### CROSS REFERENCE TO RELATED APPLICATION

The present application is a continuation application of International Patent Application No. PCT/JP2024/022922 filed on Jun. 25, 2024, which designated the U.S. and claims the benefit of priority from Japanese Patent Application No. 2023-114032 filed on Jul. 11, 2023. The entire disclosures of all of the above applications are incorporated herein by reference.

### TECHNICAL FIELD

The present disclosure relates to an information processing technology for executing route generation-related processing related to generating route data that defines a target route to be traced by an autonomous device capable of autonomous travel.

### BACKGROUND

A conceivable technique teaches a travel trajectory correction device that corrects the travel trajectory of a vehicle. When the deviation amount exceeds a threshold while the vehicle is traveling at a predetermined speed or above, the traveling trajectory correction device generates a corrected trajectory that smoothly connects the current position of the vehicle to a target point, and corrects the traveling trajectory by replacing the portion of the traveling trajectory up to the target point with the corrected trajectory.

### SUMMARY

According to an example, an information processing method is executed by a processor to perform a route generation-related process related to generation of route data that defines a target route to be traced by an autonomous device capable of autonomous travel. The information processing method may include: displaying a limit route having a curve shape that is a limit of an allowable trace of the target route by the autonomous device from a start node of the target route; and receiving an input of the target route from the start node at which the limit route is displayed. The limit route is a route that correlates with a state value for a yaw rate estimated in the autonomous device as an upper limit within an allowable range in which the trace is established, and a target speed that is targeted for autonomous traveling along the target route.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an autonomous device according to a first embodiment;

FIG. 2 is a block diagram showing the configuration of an entire system including an information processing device according to the first embodiment;

FIG. 3 is a block diagram showing the functional configuration of an information processing device according to the first embodiment;

FIG. 4 is a flowchart showing an information processing method according to the first embodiment;

FIG. 5 is a schematic diagram showing an example of a display of a limit route;

FIG. 6 is a schematic diagram showing an example of a screen during input of a target route;

FIG. 7 is a schematic diagram showing an example of a display of a next limit route;

FIG. 8 is a flowchart showing an information processing method according to a second embodiment;

FIG. 9 is a flowchart showing an information processing method according to a third embodiment; and

FIG. 10 is a flowchart showing an information processing method according to a fourth embodiment.

### DETAILED DESCRIPTION

In the technique of the conceivable technique, the traveling trajectory is corrected after the vehicle actually exhibits a behavior that deviates from the traveling trajectory. In this case, there is a possibility that the response delay that occurs between the time when the deviation is detected, the time when the traveling trajectory is corrected, and the time when the vehicle travels in accordance with the corrected traveling trajectory will cause the tracing delay for the traveling trajectory to be increased. On the other hand, when the route data that defines a target route is generated in advance, there is a possibility that convenience will be reduced if the user cannot grasp the actual traceability that the autonomous device can actually trace the target route before inputting the target route.

An object of the present embodiments is to provide an information processing method that can grasp the actual traceability of an autonomous device before inputting a target route. Another object of the present embodiments is to provide an information processing device that can grasp the actual traceability of an autonomous device before inputting a target route. Another object of the present embodiments is to provide an information processing program that can grasp the actual traceability of an autonomous device before inputting a target route. Yet another object of the present embodiments is to provide a storage medium that can grasp the actual traceability of an autonomous device before inputting a target route.

Hereinafter, a technical solution of the present embodiments for solving the problem will be described. Reference numerals in parentheses described in the claims and this column indicate correspondence relationship with specific means described in embodiments described in detail later and do not limit the technical scope of the present embodiments.

A first aspect of the present embodiments is an information processing method executed by a processor to perform a route generation-related process related to generating route data that defines a target route to be traced by an autonomous device capable of autonomous travel. The method includes: displaying a limit route having a curve shape that is a limit of an allowable trace of the target route by the autonomous device from a start node of the target route; and receiving an input of the target route from the start node at which the limit route is displayed. The limit route is a route that correlates with a state value for a yaw rate estimated by the autonomous device as an upper limit within an allowable range in which the trace is established, and a target speed that is targeted for autonomous traveling along the target route.

A second aspect of the present embodiments is an information processing device including a processor. The information processing device performs a route generation-related process related to generating route data that defines a target route to be traced by an autonomous device capable of autonomous travel. The processor is configured to execute: displaying a limit route having a curve shape that is a limit of an allowable trace of the target route by the autonomous device from a start node of the target route; and receiving an input of the target route from the start node at which the limit route is displayed. The limit route is a route that correlates with a state value for a yaw rate estimated by the autonomous device as an upper limit within an allowable range in which the trace is established, and a target speed that is targeted for autonomous traveling along the target route.

A third aspect of the present embodiments is an information processing program stored in a storage medium for executing a route generation-related process related to generating route data that defines a target route to be traced by an autonomous device capable of autonomous travel. The information processing program includes instructions to be executed by the processor. The instructions include: displaying a limit route having a curve shape that is a limit of an allowable trace of the target route by the autonomous device from a start node of the target route; and receiving an input of the target route from the start node at which the limit route is displayed. The limit route is a route that correlates with a state value for a yaw rate estimated by the autonomous device as an upper limit within an allowable range in which the trace is established, and a target speed that is targeted for autonomous traveling along the target route.

A fourth aspect of the present embodiments is a storage medium storing an information processing program including instructions to be executed by a processor in a route generation-related process related to generating route data that defines a target route to be traced by an autonomous device capable of autonomous travel. The instructions include: displaying a limit route having a curve shape that is a limit of an allowable trace of the target route by the autonomous device from a start node of the target route; and receiving an input of the target route from the start node at which the limit route is displayed. The limit route is a route that correlates with a state value for a yaw rate estimated by the autonomous device as an upper limit within an allowable range in which the trace is established, and a target speed that is targeted for autonomous traveling along the target route.

According to first to fourth aspects of the present embodiments, the limit route is displayed such that the limit route correlates with a state value for a yaw rate estimated by the autonomous device as an upper limit within an allowable range in which the trace is established, and a target speed that is targeted for autonomous traveling along the target route. Therefore, by referring to this limit route, the user can input a target route while checking whether the target route can be traced. Therefore, the actual traceability of the autonomous device can be grasped.

The following will describe embodiments of the present disclosure with reference to the drawings. It should be noted that the same reference numerals are assigned to corresponding components in the respective embodiments, and overlapping descriptions may be omitted. When only a part of the configuration is described in each embodiment, the configurations of the other embodiments described above can be applied to the other parts of the configuration. Further, not only the combinations of the configurations explicitly shown in the description of the respective embodiments, but also the configurations of the multiple embodiments can be partially combined together even if the configurations are not explicitly shown if there is no difficulty in the combination in particular.

### First Embodiment

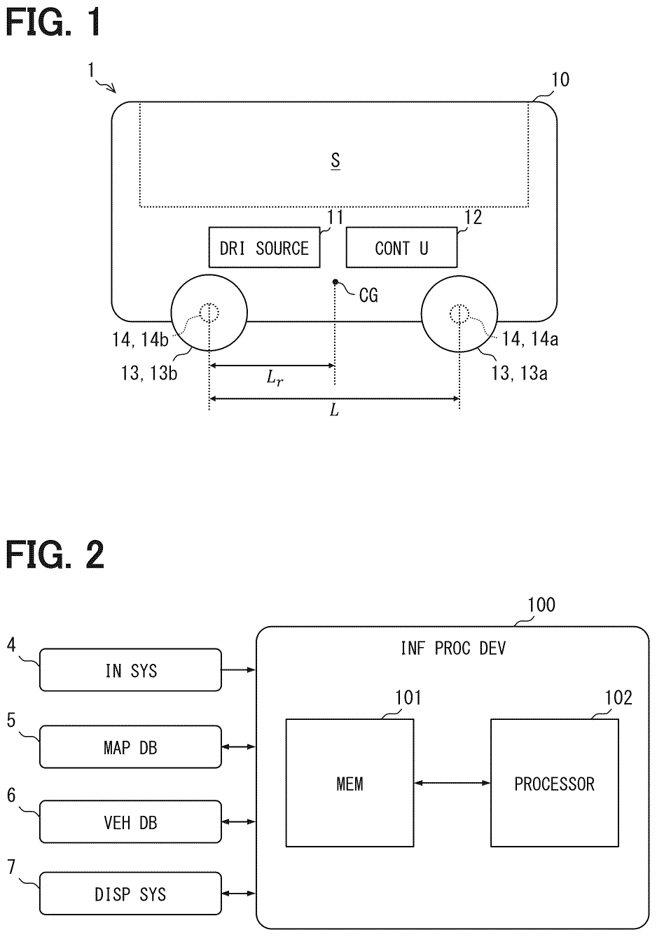

The information processing device 100 of the first embodiment executes a route generation-related process related to the generation of route data that defines the target route P of the autonomous device 1 shown in FIG. 1. The autonomous device 1 is an autonomous robot that can autonomously travel in any direction, including forward, backward, leftward, and rightward. The autonomous device 1 in the first embodiment can also be defined as an autonomous vehicle.

The autonomous device 1 includes a vehicle body 10 provided with a drive source 11, a control unit 12, wheels 13, and axles 14. The drive source 11 is, for example, an electric motor. The control unit 12 is a control device that controls the autonomous driving of the autonomous device 1, and is an ECU (i.e., Electronic Control Unit) that includes at least one dedicated computer. The control unit 12 autonomously executes acceleration/deceleration control and steering control of the autonomous device 1, thereby causing the autonomous device 1 to autonomously travel. The control unit 12 controls the autonomous driving so as to trace the target route P in accordance with the route data relating to the target route P.

The wheels 13 include a pair of front wheels 13a provided at the front of the vehicle body 10 and a pair of rear wheels 13b provided at the rear of the vehicle body 10. The axle 14 includes a front axle 14a having both ends at which a pair of front wheels 13a are rotatably fixed, and a rear axle 14b having both ends at which a pair of rear wheels 13b are rotatably fixed. The vehicle body 10 is provided with a loading space S for loading cargo. The loading space S is formed, for example, as a space that is open upward, by being partitioned at front, rear, left and right sides by parts of the vehicle body 10. The loading space S may be formed as a space that opens to the side of the vehicle body 10, for example, or may simply be a space above the upper surface of the vehicle body 10 as a loading surface.

The autonomous device 1 realizes the autonomous driving by traveling so as to trace a predetermined target route P from a start point to a destination point. The information processing device 100 executes the display to the user of the autonomous device 1 to support the user to determine the target route P in advance before the autonomous device 1 departs. Specifically, the information processing device 100 displays, to the user, the limit route PL that is allowed to be traced by the autonomous device 1.

As shown in FIG. 2, the information processing device 100 is connected to an input system 4, a map database (i.e., DB) 5, a vehicle DB 6, and a display system 7 via at least one of, for example, a local area network (i.e., LAN) line, a wire harness, an internal bus, and a wireless communication line.

The input system 4 receives an input operation by the user. The input system 4 is at least one of a mouse, a trackball, a keyboard, a touch panel, and the like. The input system 4 may include a device such as a microphone that receives voice command input.

The map DB 5 stores map information that can be used by the information processing device 100. The map DB 5 is implemented by at least one of a non-transitory tangible storage medium, such as a semiconductor memory, a magnetic medium, an optical medium, or the like. The map DB 5 may be a database for a locator that estimates self-state amount including a self-position of the autonomous device 1. The map DB 5 may be a database for a navigation unit that navigates the autonomous device 1 along a travel route. The map DB 5 may be a combination of multiple types of the above described databases.

The map information in the map DB 5 includes at least horizontal two-dimensional position information about surrounding objects O that are disposed in the facility area and that may become obstacles when the autonomous device 1 travels. For example, the map information may be point group data including a group of reflection points of surrounding objects O acquired by an external sensor such as LIDAR (i.e., Light Detection and Ranging/Laser Imaging Detection and Ranging). In this case, each reflection point has position information. Alternatively, the map information may be image data acquired by imaging a group of reflection points projected onto a bird's-eye view plane. The map information may include three-dimensional position information including the height information of the surrounding object O.

The vehicle DB 6 stores information (i.e., vehicle information) related to the autonomous device 1 that can be used by the information processing device 100. The vehicle DB 6 includes at least one type of non-transitory tangible storage medium, such as a semiconductor memory, a magnetic medium, or an optical medium. The vehicle information in the vehicle DB 6 includes information about the autonomous device 1 necessary for displaying the limit route PL. For example, the vehicle information includes dimensional information of the autonomous device 1. The dimension information includes at least the distance Lr from the center of gravity CG of the vehicle to the rear axle 14b.

The vehicle DB 6 stores the dimension information in association with the identification information of the autonomous device 1. Here, the identification information is information that indicates the vehicle type of the autonomous device 1, such as the product name, model number, or model name. That is, the vehicle DB 6 stores various information so that, with respect to the designation of the vehicle type of the autonomous device 1, dimension information corresponding to the vehicle type can be referred to.

The display system 7 displays the information to the user. Specifically, the display system 7 displays the target route P and an estimated travel area R (described later) together with the map information of the target area. The display system 7 is at least one type of panel, such as a liquid crystal panel or an organic EL panel.

The information processing device 100 is a computer including at least one memory 101 and one processor 102. The memory 101 is at least one type of non-transitory tangible storage medium of, for example, a semiconductor memory, a magnetic medium, and an optical medium, for non-transitory storing computer readable programs, data, and the like. Here, “storage” may refer to accumulation in which data is stored even when the computer is turned off, or may refer to temporary storage in which data is erased when the computer is turned off. For example, the processor 102 may include, as a core, at least one of a central processing unit (i.e., CPU), a graphics processing unit (i.e., GPU), a reduced instruction set computer (i.e., RISC) CPU, a data flow processor (i.e., DFP), a graph streaming processor (i.e., GSP), or the like.

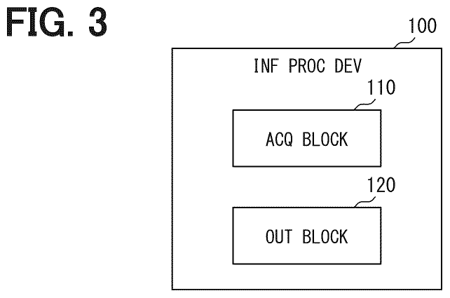

In the information processing device 100, the processor 102 executes a plurality of instructions included in an information processing program stored in the memory 101 in order to control the display of the route data defining the target route P to be traced by the autonomous device 1. As a result, the information processing device 100 forms a plurality of functional blocks for controlling the display of the route data that defines the target route P to be traced by the autonomous device 1. The plurality of functional blocks formed in the information processing device 100 include an acquisition block 110 and an output block 120 as shown in FIG. 3.

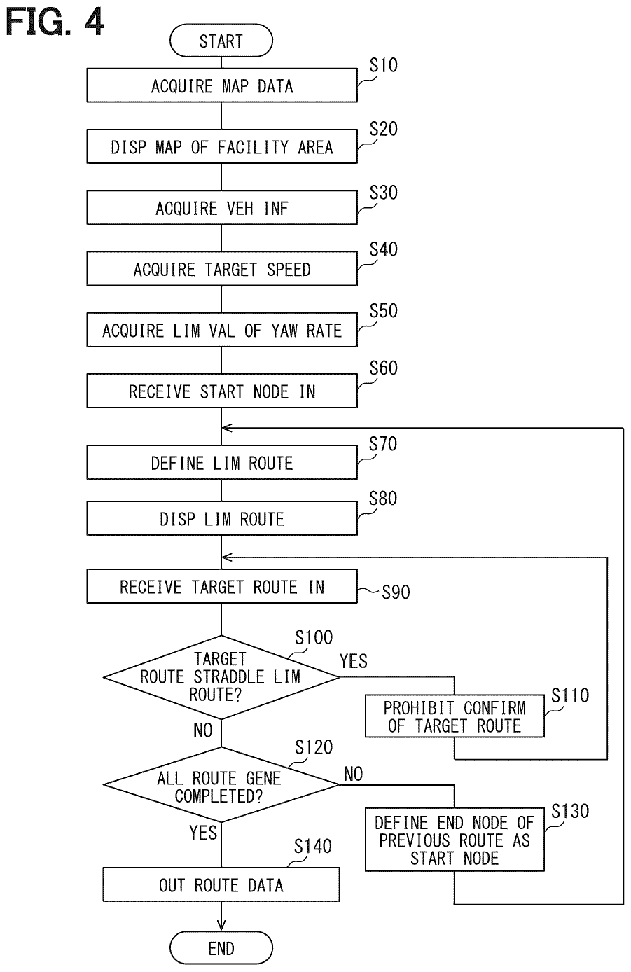

The flow of an information processing method in which the information processing device 100 executes a series of route generation related processes in cooperation with these blocks 110 and 120 will be described below with reference to FIG. 4. Hereinafter, this processing flow may be referred to as an information processing flow. This processing flow is repeatedly executed while the computer of the information processing device 100 is activated. It should be noted that each “S” in this processing flow represents a plurality of steps executed by a plurality of instructions included in the information processing program in order to execute the route generation related process.

First, in S10, the acquisition block 110 acquires, from the map DB 5, map information about the facility area in which the autonomous device 1 is used. In the next step S20, the output block 120 converts the acquired map information into an image and displays the image on the display system 7 as a map of the facility area. In this facility map, at least surrounding objects O, such as buildings and installations, that may become obstacles when the autonomous device 1 travels are displayed. In the facility map, the road markings and the like may be further displayed.

Then, in S30, the acquisition block 110 acquires the vehicle information of the autonomous device 1. Specifically, the acquisition block 110 accepts the input of the user's identification information via the input system 4, and reads out the vehicle information of the autonomous device 1 corresponding to the identification information from the vehicle DB 6.

In the following step S40, the acquisition block 110 acquires the target speed V of the autonomous device 1. The target speed V is a target traveling speed of the autonomous device 1 when traveling along the target route P that is to be input. The acquisition block 110 acquires the target speed V by, for example, receiving an input of the target speed V via the input system 4. Alternatively, the acquisition block 110 may acquire the predetermined target speed V by reading the target speed from a storage medium such as the memory 101.

Then, in S50, the acquisition block 110 acquires the yaw rate limit value γₘₐₓ. The acquisition block 110 acquires the yaw rate limit value γₘₐₓ as a value input by the user via the input system 4, for example. The yaw rate limit value γₘₐₓ is the magnitude of the yaw rate estimated for the autonomous device 1 as the upper limit of the allowable range in which a trace is established. That is, the yaw rate limit value γₘₐₓ is a value estimated as a value at which tracing of the target route P becomes substantially impossible if traveling at a yaw rate greater than or equal to yaw rate limit value γₘₐₓ. The yaw rate limit value Vmax may be a value that is specified in advance and stored in the memory 101 or the like. The yaw rate limit value γₘₐₓ is an example of a “state value for the yaw rate”. In the next step S60, the acquisition block 110 receives the input of the start node Ns from the user via the input system 4. For example, the acquisition block 110 receives the input of the start node Ns by clicking an arbitrary position on the facility map displayed on the screen of the display system 7 with a mouse or by inputting coordinates with a keyboard.

Then, in S70, the output block 120 defines a limit route PL extending from the start node Ns. The limit route PL is a route having a curve shape that is the limit of the allowable tracing of the target path P by the autonomous device 1. The limit route PL is a route that correlates with the target speed V and the yaw rate limit value γₘₐₓ, which is the upper limit within the allowable range in which the trace is established. In other words, the limit route PL is a route that is defined in accordance with the yaw rate limit value Vmax and the target speed V. More specifically, the limit route PL is a route that is further defined in accordance with the vehicle information.

To define the limit route PL, the output block 120 simulates the transition of the coordinate position (xₖ, yₖ) and the yaw angle φₖ when the autonomous device 1 travels around a curve (i.e., turns) from the position of the start node Ns at the target speed V so as to maintain the yaw rate limit value Vmax. The coordinate system here is a orthogonal coordinate system fixed relative to the road surface. The output block 120 uses the travel trajectory as the simulation result to adopt as the limit route PL. The output block 120 executes simulations for both of a case where the autonomous device 1 turns right and a case where the autonomous device 1 turns left from the position of the start node Ns, and defines two patterns of limit routes PL. Here, left and right refer to the left and right in the direction of travel of the autonomous device 1. For example, the output block 120 executes a simulation of a turning the autonomous device 1 without assuming the presence of a surrounding object O.

For example, the output block 120 simulates the travel of the autonomous device 1 using a two-wheel model that regards the autonomous device 1 as a two-wheeled vehicle with virtual front and rear wheels. The output block 120 updates the coordinate position (xₖ, yₖ) and yaw angle φₖ of the traveling autonomous device 1 at every predetermined distance step ds. The yaw angle φₖ here is a parameter that indicates the attitude of the autonomous device 1 at the position (xₖ, yₖ), and specifically, is the angle formed between the route tangent at that position and the x-axis. Here, the subscript k in xₖ, yₖ, and φₖ is a natural number that is 0 at the initial position, that is, at the start node Ns, and increases by 1 with each update.

The slip angle β of the autonomous device 1 turning at a target speed V and a yaw rate limit value γₘₐₓ, with a distance Lr from the center of gravity CG to the rear axle 14b, corresponds to the following expression (1). The sign of the right side of the expression (1) is selectively determined depending on the turning direction.

$$( Expression 1 )$$

$$β = \pm \frac{{L}_{r}}{V} {γ}_{max} \qquad ( 1 )$$

The position (xₖ₊₁, yₖ₊₁) and yaw angle φₖ₊₁ after a distance step ds from the position (xₖ, yₖ) and yaw angle φₖ correspond to the following expressions (2) to (4).

$$( Expression 2 )$$

$${x}_{k + 1} = {x}_{k} + cos ( {ϕ}_{k} + β ) \cdot ds \qquad ( 2 )$$

$$( Expression 3 )$$

$${y}_{k + 1} = {y}_{k} + sin ( {ϕ}_{k} + β ) \cdot ds \qquad ( 3 )$$

$$( Expression 4 )$$

$${ϕ}_{k + 1} = {ϕ}_{k} + \frac{{γ}_{max}}{V} \cdot ds \qquad ( 4 )$$

The output block 120 executes updates any number of times to acquire a set of coordinate positions (xₖ, yₖ) of the autonomous device 1 when turning while maintaining the yaw rate limit value γₘₐₓ as a travel trajectory that defines the limit route PL. The distance step ds and the number of update times may be set by the user or may be preliminarily determined.

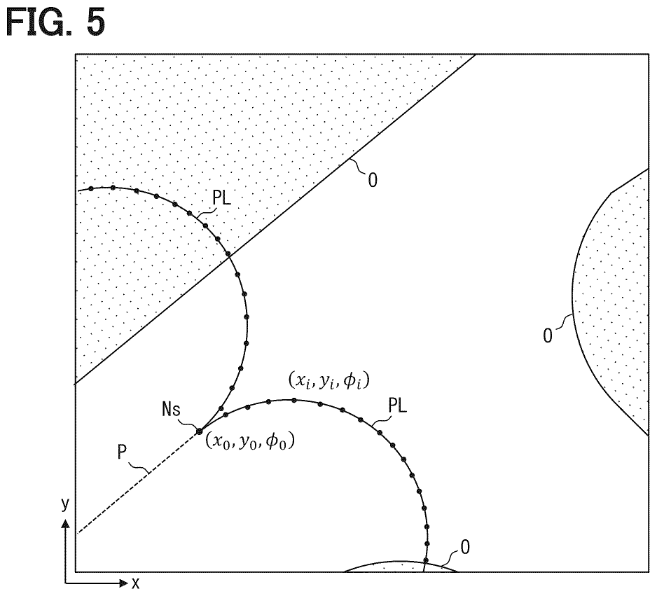

In the next step S80, the output block 120 displays the limit route PL on the display system 7. As shown in FIG. 5, the output block 120 displays the limit route PL as a line-shaped object having a curve shape extending from the start node Ns based on the information of the point group at the coordinate positions (xₖ, yₖ). That is, the output block 120 converts the coordinate position (xₖ, yₖ) into a position on the display screen of the display system 7, and displays the limit route PL by interpolating between the coordinate positions (xₖ, yₖ) using a curve. The subscript i in FIG. 5 is the number of any point that defines the limit route PL. Furthermore, even if the surrounding object O is displayed within the display range of the limit route PL, the output block 120 may simply display the limit route PL so as to be superimposed on the surrounding object O.

By displaying the limit route PL, the display system 7 will display an input allowable area where the input of the target route P is allowed and an input prohibited area where the input of the target route P is prohibited, with the limit route PL as the boundary line. The input allowable area can also be defined as a travel allowable area in which the autonomous device 1 is allowed to travel. The input prohibited area can also be defined a travel prohibition area in which the autonomous device 1 is prohibited to travel. Depending on the distance step ds and the number of update times, the limit route PL may be displayed to the end of the limit route PL on the display screen. In other words, the limit route PL may be displayed in a disconnected state within the display screen.

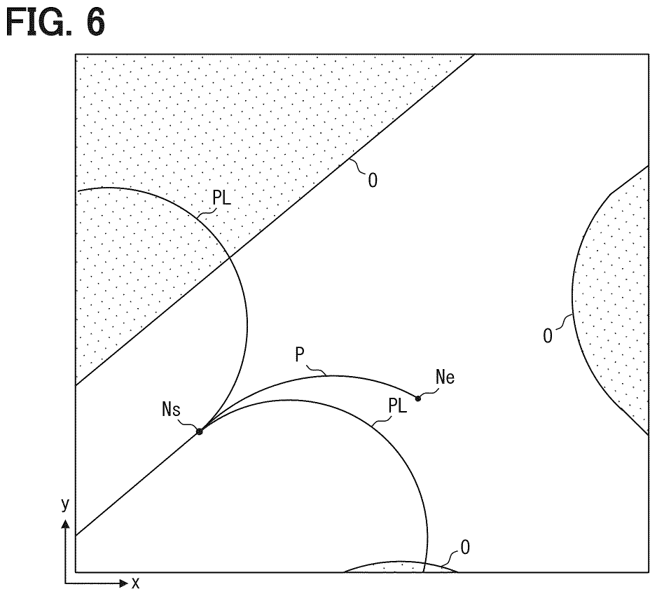

In S90, the target route P input by the user as shown in FIG. 6 is received via the input system 4 based on the display system 7 after the limit route PL is displayed. For example, a target route P set by a user is defined by a start node Ns, an end node Ne, and route lines connecting the nodes. In more detail, by defining the start node Ns and the end node Ne on the displayed facility map by mouse clicks or coordinate input, route lines connecting each node between the start node Ns and the end node Ne are also defined on the facility map. For example, the target route P is displayed as an image object in a vector format with at least a start node Ns and an end node Ne as vertices.

Therefore, by the user changing the positions of these vertices and the directions and magnitudes of the vectors from the vertices, the shape of the target route P can be changed to suit the user's request. The direction and magnitude of the vectors from the vertices can be changed by, for example, operating linear handles (not shown) extending from these vertices with a mouse or the like. In addition to the nodes Ns and Ne, vertices that define the shape of the target route P may be added arbitrarily by the user.

Then, in S100, the acquisition block 110 determines whether the target route P input by the user straddles the limit route PL. For example, the acquisition block 110 determines that the target route P straddles the limit route PL when the target route P and the limit route PL intersect or overlap with each other. If it is determined that the target route P straddles the limit route PL, the flow proceeds to S110. In S110, the output block 120 prohibits the confirmation of the target route P. For example, the output block 120 prohibits the input of the next target route P having the end node Ne of the current target route P as the start node Ns until a correction of the target route P is input. The output block 120 may notify the user via the display system 7 that the target route P straddles the limit route PL.

If it is determined in S100 that the target route P does not straddle the limit route PL, the flow proceeds to S120. In S120, the acquisition block 110 determines whether or not the generation of the entire target route P to the final destination has been completed. For example, the acquisition block 110 determines that the target route P has been confirmed when the user has input via the input system 4 to determine that the generation of the target route P has been completed. If it is determined that the generation of all the target routes P is not completed, the flow proceeds to S130.

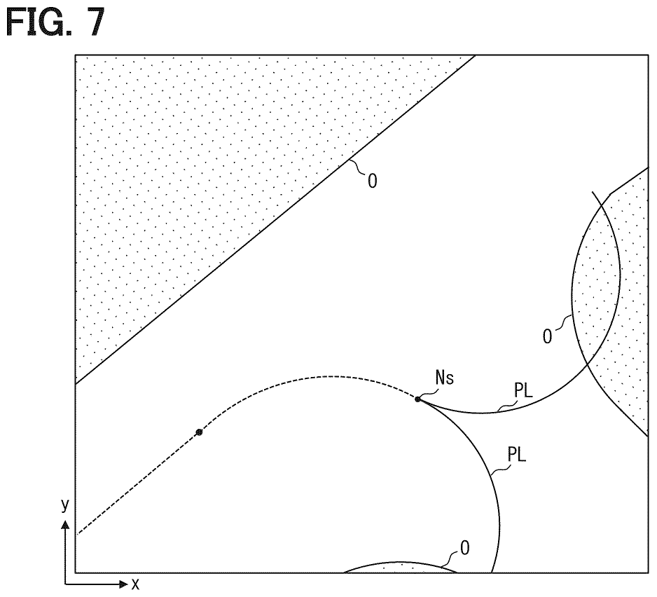

In S130, the acquisition block 110 defines the end node Ne of the target route P input in the immediately preceding S90 as the start node Ns of the target route P to be input next. Specifically, the acquisition block 110 reads the coordinates of the end node Ne of the immediately preceding target route P as the coordinate position of the next start node Ns. After S130, the flow returns to S70. By repeating the processing of S70 to S130, each time the user inputs a target route P, a limit route PL is displayed to guide the input of a new target route P that continues from the target route P (see FIGS. 5 to 7).

On the other hand, if it is determined in S120 that the generation of all target routes P has been completed, the flow proceeds to S140. In S140, route data relating to the confirmed target route P is output. The route data is output by, for example, storing the route data in a storage medium such as the memory 101 or an external memory, or transmitting the route data to the autonomous device 1. The information processing device 100 repeats the above process until the user sets a target route P to the final destination point of the autonomous device 1.

According to the first embodiment described above, a limit route PL is displayed that correlates with the yaw rate limit value γₘₐₓ estimated for the autonomous device 1 as the upper limit within the allowable range in which a trace is established, and the target speed V that is targeted for autonomous driving along the target path P. Therefore, by referring to this limit route PL, the user can input the target route P while checking whether the trace of the target route P can be established. Therefore, the actual traceability of the autonomous device 1 can be grasped.

### Second Embodiment

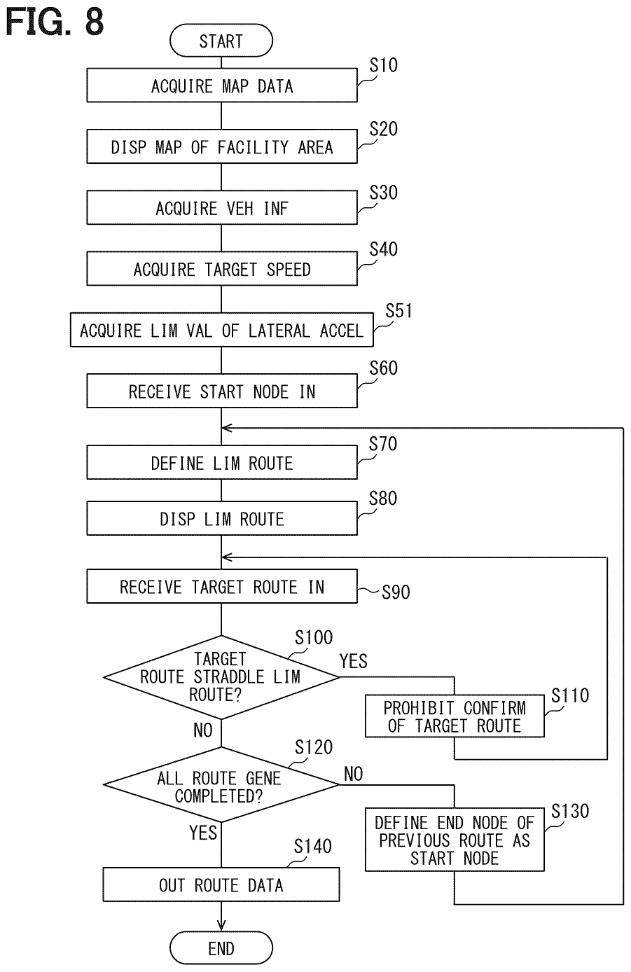

As shown in FIG. 8, the second embodiment is a modification of the first embodiment.

The information processing device 100 of the second embodiment proceeds to S51 after the process of S40. In S51, the acquisition block 110 acquires the lateral acceleration limit value aₗₘₐₓ instead of the yaw rate limit value γₘₐₓ. The lateral acceleration limit aₗₘₐₓ is the magnitude of the lateral acceleration estimated for the autonomous device 1 as the upper limit of acceleration for establishing a trace. In other words, the lateral acceleration limit value aₗₘₐₓ is a value that is estimated to make it substantially impossible to trace the target route P if traveling at a lateral acceleration greater than this value. After S51, the flow proceeds to S60 and S70.

In S70 of this embodiment, the output block 120 converts the lateral acceleration limit value aₗₘₐₓ into the yaw rate limit value γₘₐₓ in the definition of the limit route PL. The lateral acceleration limit value aₗₘₐₓ corresponds to the following expression (5) depending on the target speed V and the yaw rate limit value γₘₐₓ. That is, the lateral acceleration limit value aₗₘₐₓ is an example of a “state value for the yaw rate”.

$$( Expression 5 )$$

$${a}_{lmax} = V {γ}_{max} \qquad ( 5 )$$

Therefore, the output block 120 can convert the lateral acceleration limit value aₗₘₐₓ into a yaw rate limit value γₘₐₓ as a value correlated to the target speed V. The output block 120 calculates the slip angle β corresponding to the expression (1) from the converted yaw rate limit value γₘₐₓ. The output block 120 then defines the limit route PL by updating the coordinate position (xₖ, yₖ) and yaw angle φₖ corresponding to expressions (2) to (4) from the yaw rate limit value γₘₐₓ and slip angle β. Therefore, the output block 120 of the second embodiment defines a limit route PL that correlates with the yaw rate limit value γₘₐₓ at which the lateral acceleration correlates with the target speed V and reaches the lateral acceleration limit value aₗₘₐₓ.

### Third Embodiment

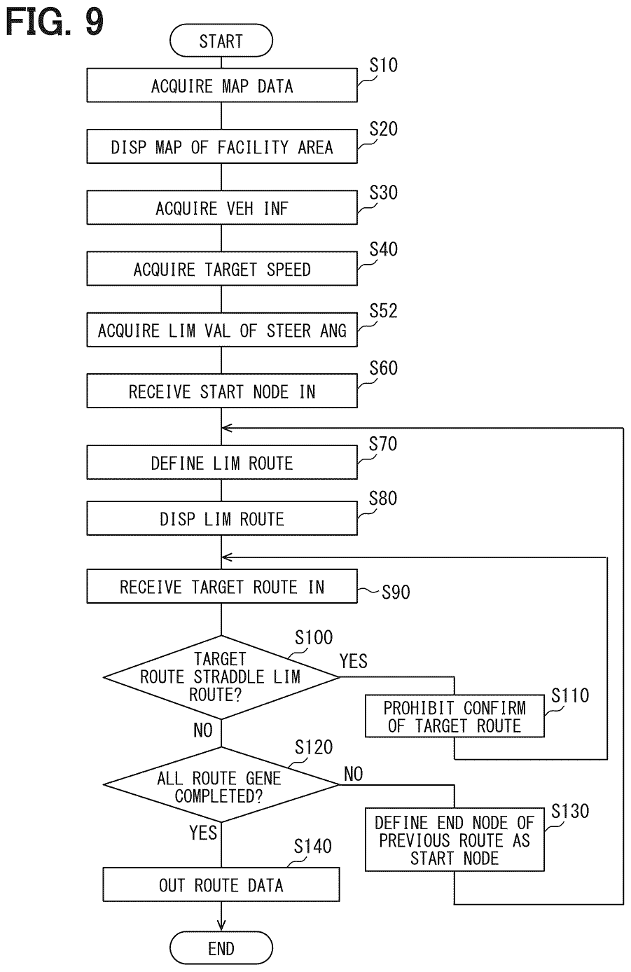

As shown in FIG. 9, the third embodiment is a modification of the first embodiment.

The information processing device 100 of the third embodiment proceeds to S52 after the process of S40. In S52, the acquisition block 110 acquires the steering angle limit value δₘₐₓ instead of the yaw rate limit value γₘₐₓ. The steering angle limit value δₘₐₓ is the magnitude of the steering angle estimated for the autonomous device 1 as the upper limit of the steering angle at which the trace is established. In other words, the steering angle limit value δₘₐₓ is a value that is defined as making it substantially impossible to trace the target route P if the vehicle is travelling at a steering angle greater than this value. After S52, the flow proceeds to S60 and S70.

In S70 of this embodiment, the output block 120 converts the steering angle limit value δₘₐₓ into the yaw rate limit value γₘₐₓ in the definition of the limit route PL. In the two-wheel model, the steering angle limit value δₘₐₓ corresponds to the following expression (6) which depends on the target speed V, the wheelbase L, and the yaw rate limit value γₘₐₓ. The steering angle limit value δₘₐₓ is an example of a “state value for the yaw rate”.

$$( Expression 6 )$$

$${δ}_{max} = \frac{L}{V} {γ}_{max} \qquad ( 6 )$$

Therefore, the output block 120 can convert the steering angle limit value δₘₐₓ into the yaw rate limit value γₘₐₓ as a value correlated with the target speed V. The output block 120 calculates the slip angle β corresponding to the expression (1) from the converted yaw rate limit value γₘₐₓ. The output block 120 then defines the limit route PL by updating the coordinate position (xₖ, yₖ) and yaw angle φₖ corresponding to expressions (2) to (4) from the yaw rate limit value γₘₐₓ and slip angle β. Therefore, the output block 120 of the third embodiment defines a limit route PL that correlates with the yaw rate limit value γₘₐₓ at which the steering angle correlates with the target speed V and reaches the steering angle limit value δₘₐₓ.

### Fourth Embodiment

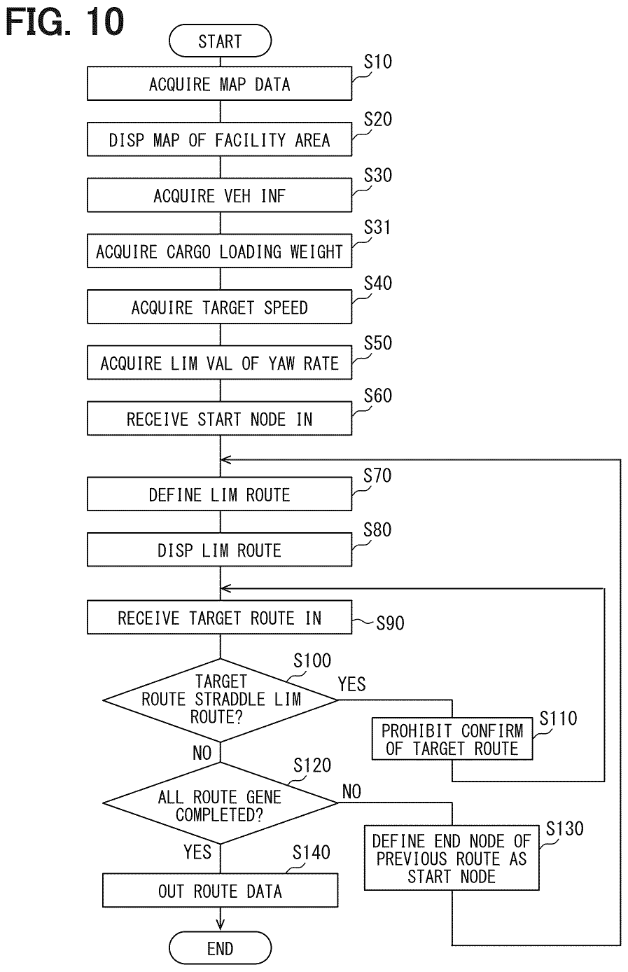

A fourth embodiment shown in FIG. 10 is a modification of the first embodiment. In the fourth embodiment, the information processing device 100 defines and displays the limit route PL as a route that also correlates with the weight of the autonomous device 1.

In the fourth embodiment, the vehicle DB 6 further stores the vehicle body weight of the autonomous device 1 as vehicle information. The vehicle weight stored in the vehicle DB 6 is the weight in an unladen state where no cargo is carried. The vehicle DB 6 stores the vehicle weight in association with the identification information of the autonomous device 1.

As shown in FIG. 10, the information processing flow in the fourth embodiment proceeds to S31 after S30. In S31, the acquisition block 110 receives an input regarding the load weight of the cargo on the autonomous device 1.

Furthermore, in S70 of this flow, the output block 120 defines a limit route PL as a route correlated with the weight in addition to the yaw rate limit value Vmax and the target speed V. In this case, the output block 120 may execute a simulation using a dynamic model and define the resulting trajectory as the limit route PL.

### Other Embodiments

While multiple embodiments are described above, the present disclosure is not interpreted as being limited to the embodiments and can be applied to various embodiments and combinations without departing from a spirit of the present disclosure.

In a modification example, the information processing device 100 may acquire a plurality of state values that are individually defined. In this case, the information processing device 100 defines the limit route PL according to the state value with the strictest allowable range for tracing among the plurality of state values. For example, when the yaw rate limit value γₘₐₓ, the lateral acceleration limit value aₗₘₐₓ, and the steering angle limit value δₘₐₓ are acquired, the information processing device 100 converts the lateral acceleration limit value aₗₘₐₓ and the steering angle limit value δₘₐₓ into a yaw rate. Then, the information processing device 100 may select the most severe value among the state values, that is, the value with the smallest magnitude as the yaw rate, as the state value to be used in defining the limit route PL.

In a modification example, the information processing device 100 may determine that the target route P does not straddle the limit route PL when the target route P overlaps the limit route PL without intersecting with the limit route PL.

In a modification example, the information processing device 100 may accept an input of a new target speed V for each target route P. In a modification example, the information processing device 100 may also receive an input of a target speed V that changes depending on the travel from the start node Ns.

In a modification example, the computer constituting the information processing device 100 may have at least one of a digital circuit and an analog circuit as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. The digital circuit may include a memory storing a program.

In a modification example, the memory 101 storing the information processing program may be a portable storage medium that is removable from the information processing device 100. In this case, the memory 101 may be a storage medium in which an information processing program is stored so as to be readable by the information processing device 100 as a computer, and which is used to carry the program to be installed in the information processing device 100. Alternatively, the memory 101 may be a storage medium of a server device that distributes an information processing program to the information processing device 100 of the user.

In a modification example, the host mobile body to which the information processing device 100 is applied may be, for example, an autonomous traveling robot capable of transporting luggage or collecting information by autonomous traveling or remote traveling. In addition to the above-described embodiments and modifications, the present embodiments may be implemented in forms of a control device mountable on a host moving object and including at least one processor 102 and at least one memory 101, a processing circuit (for example, a processing ECU, etc.) or a semiconductor device (e.g., semiconductor chip, etc.)

### Embodiments of Technical Features

This specification discloses multiple technical features described in multiple items listed below. Some features may be described in a multiple dependent form, in which subsequent features alternatively refer to preceding features. Some features may be described in a multiple dependent form referring to another multiple dependent form. These features described in a multiple dependent form define multiple technical features.

### (Technical Feature 1)

An information processing method is executed by a processor (102) to perform a route generation-related process related to generation of route data that defines a target route (P) to be traced by an autonomous device (1) capable of autonomous travel. The information processing method includes: displaying a limit route (PL) having a curve shape that is a limit of an allowable trace of the target route by the autonomous device from a start node (Ns) of the target route; and receiving an input of the target route from the start node at which the limit route is displayed. The limit route is a route that correlates with a state value for a yaw rate estimated in the autonomous device as an upper limit within an allowable range in which the trace is established, and a target speed that is targeted for autonomous traveling along the target route.

### (Technical Feature 2)

In the information processing method according to technical feature 1, the upper limit of the yaw rate within the allowable range includes the yaw rate at which a lateral acceleration becomes an upper limit of acceleration in correlation with the target speed.

### (Technical Feature 3)

In the information processing method according to technical feature 1 or 2, the upper limit of the yaw rate within the allowable range includes the yaw rate at which a steering angle becomes an upper limit of the steering angle in correlation with the target speed.

### (Technical Feature 4)

The information processing method according to any one of technical features 1 to 3, further includes generating the route data defining an input target route.

### (Technical Feature 5)

In the information processing method according to technical feature 4, the generating of the route data includes outputting a generated route data.

The above technical features 1 to 5 may be implemented in the form of an information processing device 100, an information processing program, and a storage medium.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information processing method executed by a processor to perform a route generation-related process related to generation of route data that defines a target route to be traced by an autonomous device capable of autonomous travel, the information processing method comprising:
displaying a limit route having a curve shape that is a limit of an allowable trace of the target route by the autonomous device from a start node of the target route; and
receiving an input of the target route from the start node at which the limit route is displayed, wherein:
the limit route is a route that correlates with a state value for a yaw rate estimated in the autonomous device as an upper limit within an allowable range in which the trace is established, and a target speed that is targeted for autonomous traveling along the target route.

2. The information processing method according to claim 1, wherein:
the upper limit of the yaw rate within the allowable range includes the yaw rate at which a lateral acceleration becomes an upper limit of acceleration in correlation with the target speed.

3. The information processing method according to claim 1, wherein:
the upper limit of the yaw rate within the allowable range includes the yaw rate at which a steering angle becomes an upper limit of the steering angle in correlation with the target speed.

4. The information processing method according to claim 1, further comprising:
generating the route data defining an input target route.

5. The information processing method according to claim 4, wherein:
the generating of the route data includes outputting a generated route data.

6. The information processing method according to claim 1, further comprising:
controlling the autonomous travel of the autonomous device to trace the target route according to the route data that defines the target route.

7. The information processing method according to claim 6, wherein:
the limit route is a route defined by a yaw rate limit value and the target speed,
the information processing method further comprising:
simulating a transition of a coordinate position and a yaw angle of the autonomous device when the autonomous device travels around a curve from a position of the start node at the target speed so as to maintain the yaw rate limit value; and
adopting a travel trajectory of a simulation result as the limit route;
a coordinate system of the coordinate position is an orthogonal coordinate system fixed relative to a road surface on which the autonomous device travels; and
the simulating of the transition of the coordinate position and the yaw angle is executed using a two-wheel model that regards the autonomous device as a two-wheeled vehicle with virtual front and rear wheels.

8. An information processing device for performing a route generation-related process related to generation of route data that defines a target route to be traced by an autonomous device capable of autonomous travel, the information processing device comprising:
a processor, wherein:
the processor is configured to execute:
displaying a limit route having a curve shape that is a limit of an allowable trace of the target route by the autonomous device from a start node of the target route; and
receiving an input of the target route from the start node at which the limit route is displayed; and
the limit route is a route that correlates with a state value for a yaw rate estimated in the autonomous device as an upper limit within an allowable range in which the trace is established, and a target speed that is targeted for autonomous traveling along the target route.

9. The information processing device according to claim 8, wherein:
the processor is further configured to control the autonomous travel of the autonomous device to trace the target route according to the route data that defines the target route.

10. The information processing device according to claim 9, wherein:
the limit route is a route defined by a yaw rate limit value and the target speed,
the processor is further configured to:
simulate a transition of a coordinate position and a yaw angle of the autonomous device when the autonomous device travels around a curve from a position of the start node at the target speed so as to maintain the yaw rate limit value; and
adopt a travel trajectory of a simulation result as the limit route;
a coordinate system of the coordinate position is an orthogonal coordinate system fixed relative to a road surface on which the autonomous device travels; and
a simulation of the transition of the coordinate position and the yaw angle is executed using a two-wheel model that regards the autonomous device as a two-wheeled vehicle with virtual front and rear wheels.

11. An information processing program product stored in a storage medium for performing a route generation-related process related to generation of route data that defines a target route to be traced by an autonomous device capable of autonomous travel, the information processing program product comprising:
instructions to be executed by a processor, wherein:
the instructions includes:
displaying a limit route having a curve shape that is a limit of an allowable trace of the target route by the autonomous device from a start node of the target route; and
receiving an input of the target route from the start node at which the limit route is displayed; and
the limit route is a route that correlates with a state value for a yaw rate estimated in the autonomous device as an upper limit within an allowable range in which the trace is established, and a target speed that is targeted for autonomous traveling along the target route.

12. The information processing program product according to claim 11, wherein:
the instructions further include controlling the autonomous travel of the autonomous device to trace the target route according to the route data that defines the target route.

13. The information processing program product according to claim 12, wherein:
the limit route is a route defined by a yaw rate limit value and the target speed,
the instructions further include:
simulating a transition of a coordinate position and a yaw angle of the autonomous device when the autonomous device travels around a curve from a position of the start node at the target speed so as to maintain the yaw rate limit value; and
adopting a travel trajectory of a simulation result as the limit route;
a coordinate system of the coordinate position is an orthogonal coordinate system fixed relative to a road surface on which the autonomous device travels; and
the simulating of the transition of the coordinate position and the yaw angle is executed using a two-wheel model that regards the autonomous device as a two-wheeled vehicle with virtual front and rear wheels.

14. A storage medium for storing an information processing program that includes instructions to be executed by a processor in a route generation-related process related to generation of route data that defines a target route to be traced by an autonomous device capable of autonomous travel, wherein:
the instructions includes:
displaying a limit route having a curve shape that is a limit of an allowable trace of the target route by the autonomous device from a start node of the target route; and
receiving an input of the target route from the start node at which the limit route is displayed; and
the limit route is a route that correlates with a state value for a yaw rate estimated in the autonomous device as an upper limit within an allowable range in which the trace is established, and a target speed that is targeted for autonomous traveling along the target route.

15. The storage medium according to claim 14, wherein:
the instructions further include controlling the autonomous travel of the autonomous device to trace the target route according to the route data that defines the target route.

16. The storage medium according to claim 15, wherein:
the limit route is a route defined by a yaw rate limit value and the target speed,
the instructions further include:
simulating a transition of a coordinate position and a yaw angle of the autonomous device when the autonomous device travels around a curve from a position of the start node at the target speed so as to maintain the yaw rate limit value; and
adopting a travel trajectory of a simulation result as the limit route;
a coordinate system of the coordinate position is an orthogonal coordinate system fixed relative to a road surface on which the autonomous device travels; and
the simulating of the transition of the coordinate position and the yaw angle is executed using a two-wheel model that regards the autonomous device as a two-wheeled vehicle with virtual front and rear wheels.
